(19) United States
(12) Patent Application Publication
(10) Pub. No.: US 2010/0033482 A1
(43) Pub. Date: Feb. 11, 2010

(54) Interactive Relighting of Dynamic Refractive Objects

(75) Inventors: Kun Zhou, Beijing (CN); Xin Sun, Beijing (CN); Eric Stollnitz, Kirkland, WA (US); Baining Guo, Redmond, WA (US)

Correspondence Address: MICROSOFT CORPORATION, ONE MICROSOFT WAY, REDMOND, WA, 98052, US

(73) Assignee: Interactive Relighting of Dynamic Refractive Objects, Redmond, WA (US)

(21) Appl. No.: 12/189,763

(22) Filed: Aug. 11, 2008

(51) Int. Cl. G06T 17/00

(52) U.S. Cl. 345/424

(57) ABSTRACT

Dynamic refractive object relighting technique embodiments are presented which involve rendering an image of a refractive object in a dynamic scene by first voxelizing a representation of the surfaces of the object into a volumetric representation in the form of a rectangular voxel grid. A refractive index is assigned to each voxel based on user-input material parameters. Next, the paths of photons are traced in a step-wise manner as each photon refracts through the object. The size of each step forward is variable and based on variations in refractive index of the object. Radiance values are assigned to all the voxels that the photons traverse in their paths through the object. An output image of the refractive object is then rendered from a user-input viewpoint by tracing viewing rays from the viewpoint into the scene and calculating the amount of radiance that reaches the viewpoint along each of the rays.

### BACKGROUND

The refraction and scattering of light as it passes through different participating media (e.g., clouds, smoke, water, and so on) and translucent materials results in many beautiful and intriguing effects. For example, these effects include mirages and sunsets. They also include the caustic patterns (e.g., bright spots) seen when light rays are focused onto a surface or participating media, such as those produced by light passing through a crystal vase or water waves.

Simulating these phenomena in computer graphics takes into account the fact that participating media and translucent materials may absorb, emit and/or scatter light coming from multiple light sources. Additionally, in the case of a dynamic scene, the lighting, materials and geometry can change over time. For example, a user may want to see the effects of animating objects, editing shapes, adjusting lights, and running physical simulations. Thus, the aforementioned simulation accounts for changes in the way the materials absorb, emit and/or scatter light.

### SUMMARY

Dynamic refractive object relighting technique embodiments described herein provide for the relighting of dynamic refractive objects having complex material properties such as spatially varying refractive index and anisotropic scattering, at interactive rates. In one embodiment, this is accomplished using a rendering pipeline in which each stage runs entirely on the GPU. Generally, the rendering pipeline converts input object surfaces to volumetric data, traces the curved paths of photons as they refract through the volume, and renders arbitrary views of a resulting radiance distribution. This rendering pipeline is fast enough to permit interactive manipulation of the lighting, materials, geometry, and viewing parameters without any pre-computation.

In one embodiment, the dynamic refractive object relighting technique involves rendering an image of a refractive object in a dynamic scene by first voxelizing a representation of the surfaces of the refractive object into a volumetric representation of object in the form of a rectangular voxel grid. This is done whenever the representation of the refractive object surfaces is input in lieu of a pre-configured volumetric object representation. A refractive index is also assigned to each voxel of the volumetric object representation based on user-input material parameters. Next, the paths of photons are traced in a step-wise manner as each photon refracts through the object. The size of each step forward through the refractive object is variable and based on variations in refractive index derived from an octree representation of the object's refractive indexes. Radiance values are assigned to all the voxels that the photons traverse in their paths through the object. An output image of the refractive object is then rendered from a user-input viewpoint by tracing viewing rays from the viewpoint into the scene and calculating the amount of radiance that reaches the viewpoint along each of the rays.

It should be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a simplified rendering pipeline diagram for the dynamic refractive object relighting technique embodiments described herein.

FIG. 2 is a flow diagram generally outlining one embodiment of a process for implementing the dynamic refractive object relighting technique.

FIGS. 3A-B are a continuing flow diagram generally outlining an implementation of the part of the process of FIG. 2 involving voxelizing a representation of the surfaces of the refractive object into a volumetric representation.

FIG. 4 is a diagram showing a two-dimensional simplification of the construction of a refractive index octree in accordance with the dynamic refractive object relighting technique embodiments described herein.

FIG. 5 is a flow diagram generally outlining an implementation of the part of the process of FIG. 2 involving octree construction.

FIG. 6 is a flow diagram generally outlining an implementation of the part of the process of FIG. 2 involving photon generation.

FIG. 7 is a diagram showing how the refractive index octree is used to determine the largest step size that keeps the photon within a region of approximately constant refractive index by advancing it to the boundary of the octree node in the photon's current direction.

FIGS. 8A-C are a continuing flow diagram generally outlining an implementation of the part of the process of FIG. 2 involving adaptive photon tracing.

FIGS. 9A-B are a continuing flow diagram generally outlining an implementation of the part of the process of FIG. 2 involving rendering.

FIG. 10 is a diagram depicting a general purpose computing device constituting an exemplary system for implementing the dynamic refractive object relighting technique embodiments described herein.

### DETAILED DESCRIPTION

In the following description of dynamic refractive object relighting technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

1.0 The Dynamic Refractive Object Relighting Technique

Dynamic refractive object relighting technique embodiments described herein are used to render an image of a refractive object having an arbitrarily varying refractive index in a dynamic scene at an interactive rate, so as to depict the effects of refraction, absorption, and anisotropic scattering of light on the object. This includes rendering caustic, scattering, and absorption effects interactively, even as the scene changes. In one embodiment of the technique, a graphics processing unit (GPU) is relied upon for each stage of a rendering pipeline in order to visualize these effects without any pre-computation. The speed of this approach hinges on the use of a voxel-based representation of objects and illumination. The rendering pipeline is designed to start with on-the-fly voxelization, so that a volumetric representation can be maintained even when the input geometry is changing. Using this voxel-based representation allows a full exploitation of the GPU's parallelism in each of the subsequent pipeline stages.

In general, for each frame output, the pipeline voxelizes the input surfaces, traces photons to distribute radiance throughout the scene, and renders a view of the resulting radiance distribution. Since continuous variation is permitted in the refractive index throughout the volume, photons and viewing rays follow curved paths governed by the ray equation of geometric optics. Because of the voxel-based representation, it is possible to build an octree to further accelerate the rendering. This octree is used to choose adaptive step sizes when propagating photons along their curved paths. The GPU's rasterization speed is also utilized to update the stored radiance distribution in each stage. As a result, it is possible to render dynamic refractive objects at a rate of several frames per second.

Give the foregoing, a user can change the positions and colors of light sources while viewing the resulting effects of caustics, absorption, single scattering, and shadows. Dynamic updates to material properties of the refractive object are allowed as well. The materials within a volume are defined by three properties: the index of refraction, the extinction coefficient, and the scattering coefficient. Variations in the index of refraction determine how light rays bend as they pass through the volume. The extinction coefficient affects how much light propagates through the volume from the light sources and to the camera. The scattering coefficient determines how much the radiance within each voxel contributes to the final image. A user can also interactively deform a refractive object and view the effect of the deformation on the scene's illumination. In one embodiment, a CPU is relied upon to perform the deformation which produces a watertight triangulated surface mesh. The modified mesh is then input into the rendering pipeline. Any interactive surface modeling technique can be employed for this purpose.

1.1 The Rendering Pipeline

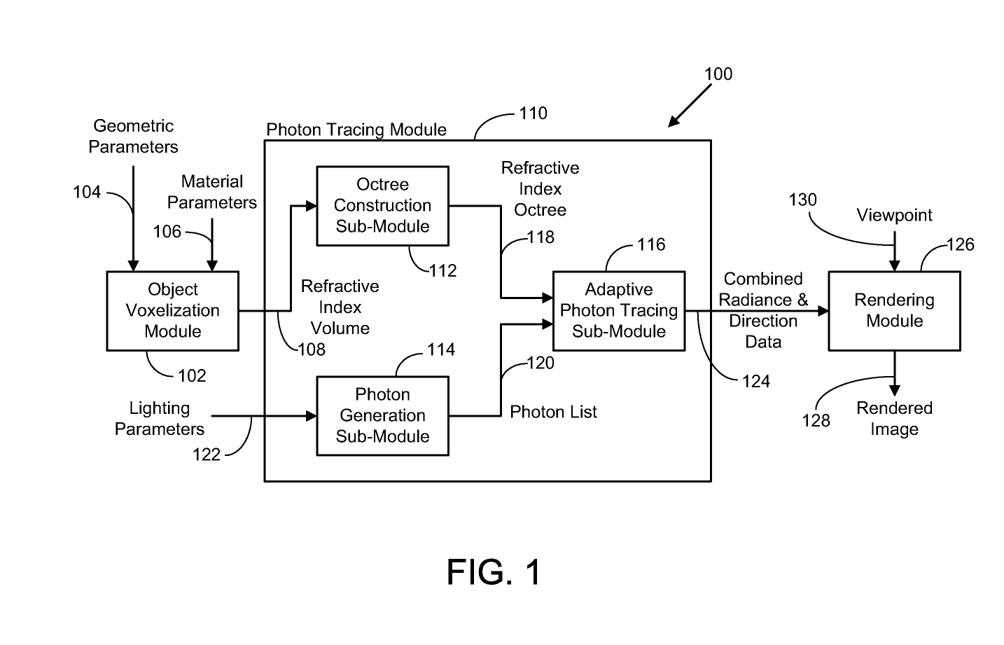

In one embodiment of the technique, rendering the effects of refraction, absorption, and anisotropic scattering in dynamic scenes at interactive rates, is generally accomplished using a rendering pipeline 100 as depicted in FIG. 1. This pipeline includes several stages, each of which can be implemented on a GPU. The pipeline takes as its input a volumetric or surface description of the scene, a set of point or directional light sources, and the desired view to be rendered. The pipeline produces a rendered image as its output. Note that during an interactive rendering session, only some of the stages need to be executed depending on what parameters are changed. For example, if the geometry of the refractive object is not changed, the voxelization stage can be skipped. Another example would be where the geometry and material of the refractive object, and the lighting parameters remain the same, but the user wishes to view the scene from a different viewpoint. In such a case, only the rendering stage needs to be performed to generate a new image.

The foregoing embodiment employs a volumetric representation of space in the form of a rectangular voxel grid. More particularly, a voxel-based representation of an index of refraction n, a scattering coefficient σ, and an extinction coefficient κ (defined as the sum of σ and an absorption coefficient α) is employed. Referring to FIG. 1, the object voxelization module 102 of the rendering pipeline 100 can harness a GPU to efficiently convert input geometric parameters 104 such as triangle-mesh surfaces, into volumetric data. This voxelization stage can be bypassed in applications that obtain volumetric data directly from physical simulations or measurements. In either case, the object voxelization module 102 is also responsible for assigning user-input material parameters 106 including a refractive index to each voxel of the volumetric object representation to produce a refractive index volume 108.

The next stage of the pipeline 100 employs a photon tracing module 110 to trace the paths of photons in a step-wise manner as each photon refracts through the object and assigning radiance values to all the voxels that the photon traverses. The size of each step forward through the refractive object is variable and based on variations in refractive index. More particularly, the photon tracing module includes three sub-modules—an octree construction sub-module 112, a photon generation sub-module 114, and an adaptive photon tracing sub-module 116.

In general, the octree construction sub-module 112 analyzes the index of refraction data of the volumetric object representation and produces a refractive index octree 118 describing the regions of space in which the refractive index is nearly constant. The photon generation sub-module 114 generates a list of photons 120 associated with each light source illuminating the scene. These photons are defined by an initial position, a direction and a radiance value, and are based on user-input lighting parameters 122 associated with one or more light source locations.

The octree information and photon list serves as input to the adaptive photon tracing sub-module 116. This sub-module 116 advances each photon along its path through the refractive object, while at each step a radiance value attributable to each photon is associated with each voxel it traverses. A combined radiance is then assigned to each voxel traversed by one or more photons after each step forward, which represents a combination of the radiance attributed to each photon traversing the voxel in the current and previous steps. In addition, a combined photon direction is assigned to each voxel traversed by one or more photons after each step forward. This combined photon direction represents a combination of the directions of each photon traversing the voxel in the current and previous steps. Thus, the output of the adaptive photon tracing sub-module 116 is the aforementioned per-voxel combined radiance and combined photon direction data 124.

Finally, a rendering module 126 is responsible for rendering an output image 128 of the refractive object from a user-input viewpoint 130 by tracing viewing rays from the viewpoint into the scene and calculating the amount of radiance that reaches the viewpoint along each of the rays.

Because index of refraction of the volumetric media can vary continuously throughout space, both the photons and the viewing rays follow curved paths rather than the straight-line paths. A curved light path x(s) is related to the scalar field n of refractive index by the ray equation of geometric optics:

$$\frac{d}{d s} ( n \frac{d x}{d s} ) = ∇ n . \qquad ( 1 )$$

By defining

$$v = n \frac{d x}{d s} , \qquad Eq . ( 1 )$$

can be rewritten as a system of first-order differential equations:

$$\begin{matrix}\frac{d x}{d s} = \frac{v}{n} & ( 2 ) \\ \frac{d v}{d s} = ∇ n . & ( 3 )\end{matrix}$$

A forward-difference discretization of the continuous equations is used to march along piecewise-linear approximations to these curves:

$$\begin{matrix}{x}_{i + 1} = {x}_{i} + \frac{Δ s}{n} {v}_{i} & ( 4 ) \\ {v}_{i + 1} = {v}_{i} + Δ s ∇ n . & ( 5 )\end{matrix}$$

It is noted that the step size Δs is changed as photons are advanced along these curves to adapt to the surrounding variation in refractive index. In a region of nearly constant refractive index, a single large step is taken, while in a region where the index varies greatly, many small steps are taken in order to accurately trace the light path. The aforementioned octree data structure is used to determine how large a step can be taken from any given position.

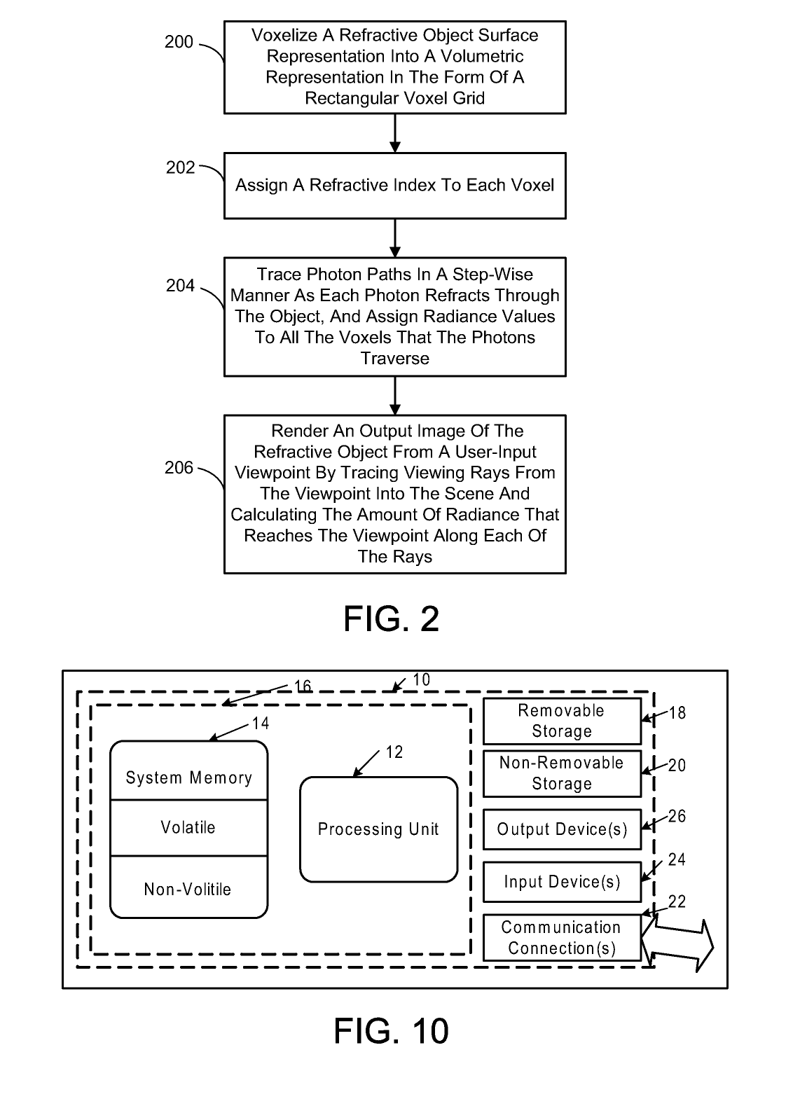

In view of the foregoing, one general embodiment of a process for implementing the dynamic refractive object relighting technique using the rendering pipeline is shown in FIG. 2. This involves first voxelizing a representation of the surface of the refractive object into a volumetric representation of object in the form of a rectangular voxel grid (200). A refractive index is then assigned to each voxel of the volumetric object representation based on user-input material parameters (202). The paths of photons are traced in a step-wise manner as each photon refracts through the object, and radiance values are assigned to all the voxels that the photons traverse (204). An output image of the refractive object is then rendered from a user-input viewpoint by tracing viewing rays from the viewpoint into the scene and calculating the amount of radiance that reaches the viewpoint along each of the rays (206).

The modules of the rendering pipeline depicted in FIG. 1, and the process actions of FIG. 2, will now be described in more detail in the following sections.

1.1.1 Object Voxelization

The object voxelization generally takes a watertight triangulated surface mesh as an input and produces a volumetric texture as output. In one embodiment, this relies on the rasterization and clipping operations of a GPU to assign a value of one to voxels whose centers are inside the mesh and zero to voxels whose centers are outside the mesh. This is accomplished by rendering the mesh into each slice of the volume texture in turn, with the near clipping plane set to the front of the slice, using a fragment shader that increments the voxel values within back-facing triangles and decrements the voxel values within front-facing triangles.

The voxelization requires smoothly varying values within the refractive index volume in order to avoid undesirable rendering artifacts. To this end, it is desired that the voxelization assign fractional coverage values to those voxels through which the surface passes. In one embodiment, this is accomplished by first super-sampling the volume by voxelizing the mesh into a texture that is four times larger in each dimension than the output. The resulting texture needs to be down-sampled, but the cost of reading 4×4×4=64 texture samples for each of the output voxels can be prohibitive. Instead, a strategy is utilized that only requires down-sampling for output voxels near the surface. The mesh is voxelized again into a texture at the desired output resolution, then a 3×3×3 neighborhood around each of the resulting voxels is considered. If these 27 voxels all have the same value, no further work is required. If the voxel values differ, then the corresponding region of the super-sampled texture is down-sampled to get the fractional value.

Finally, the fractional coverage values are converted into refractive index numbers and the output texture is smoothed using, for example, a 7×7×7 or 9×9×9 approximation of a Gaussian blur kernel. Note that super-sampling effectively increases the accuracy of surface normals (as represented by the gradient of the refractive index), while blurring spreads the boundary region over a wider band of voxels.

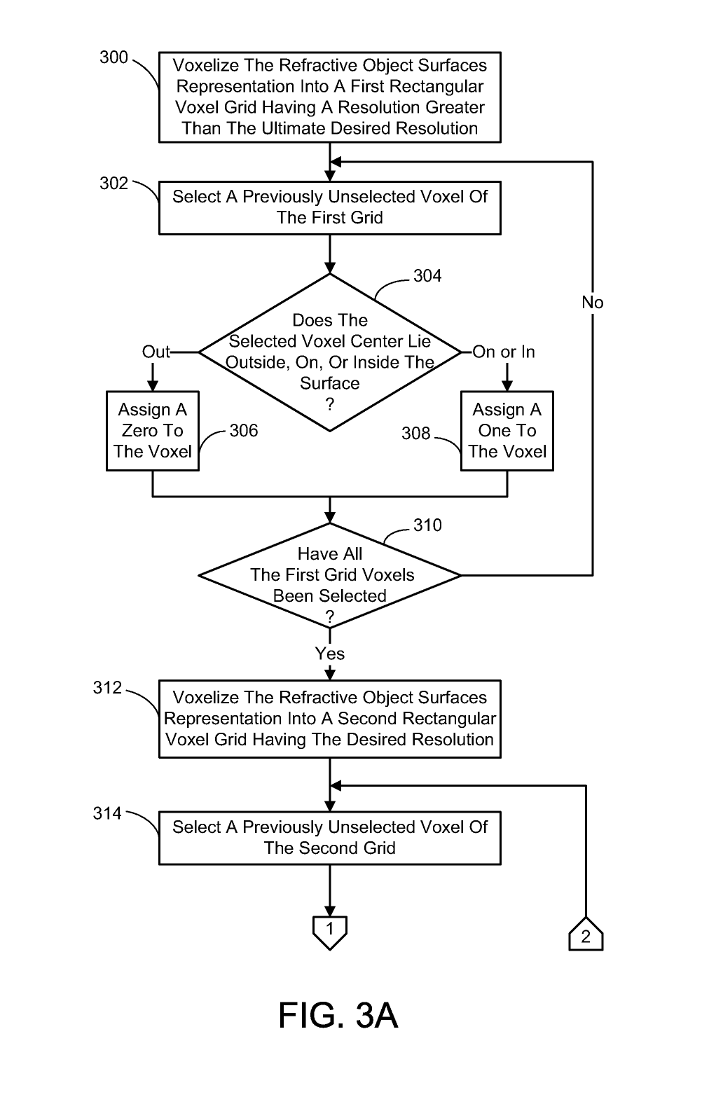

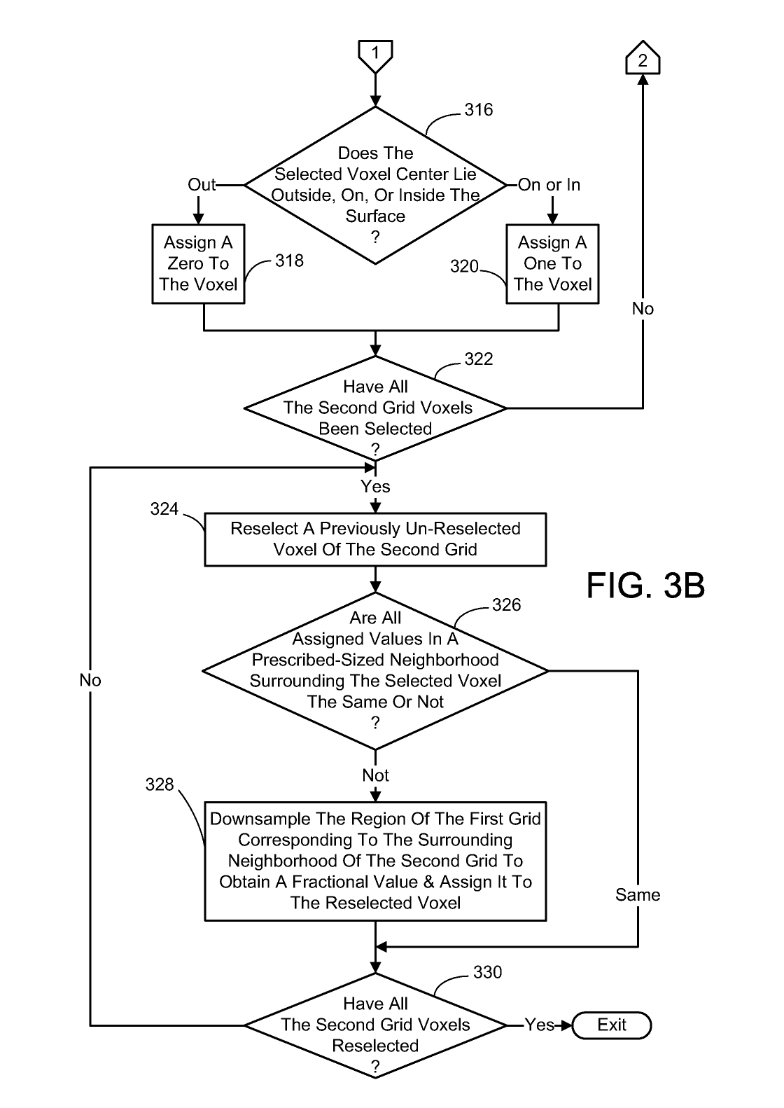

In one embodiment, voxelizing a representation of the surfaces of the refractive object into a volumetric representation is implemented as shown in FIGS. 3A-B. First, the representation of the refractive object surfaces is voxelized into a first rectangular voxel grid (300). As indicated previously, this first grid has a prescribed resolution which is greater than that of the ultimate desired resolution. A previously unselected voxel of the first grid is selected (302), and it is determined if the center of the selected voxel lies outside, on, or inside the surface (304). If the selected voxel's center lies outside the surface, a zero is assigned to the voxel (306). If the selected voxel's center lies on or inside the surface, a one is assigned to the voxel (308). It is then determined if all the voxels of the first grid have been selected (310). If not, actions 302 through 310 are repeated.

When it is determined that all the voxels of the first grid have been selected, the representation of the refractive object surfaces is voxelized into a second rectangular voxel grid that has the aforementioned desired resolution (312). A previously unselected voxel of the second grid is selected (314), and it is determined if the center of the selected voxel lies outside, on, or inside the surface (316). If the selected voxel's center lies outside the surface, a zero is assigned to the voxel (318). If the selected voxel's center lies on or inside the surface, a one is assigned to the voxel (320). It is then determined if all the voxels of the second grid have been selected (322). If not, actions 314 through 322 are repeated until a number has been assigned to all the voxels. At this point, each of the second grid voxels are reselected one at a time. To this end, a previously un-reselected voxel of the second grid is reselected (324) and it is determined whether all the assigned values in a prescribed-sized surrounding neighborhood are the same or not (326). If they are all the same, then no change is made to the assigned value of the reselected voxel. However, if any of the assigned values in the surrounding neighborhood are not the same, the region of the first grid corresponding to the surrounding neighborhood of the second grid is downsampled to obtain a fractional value which is then assigned to the reselected voxel under consideration in lieu of its previously assigned value (328). It is then determined if all the voxels of the second grid have been reselected (330). If not, actions 324 through 330 are repeated until all the second grid voxels have been reselected, at which time the procedure ends.

Assigning a refractive index to each voxel of the foregoing second grid would then involve assigning a refractive index to each voxel based on the user input material parameters, where the refractive index assigned to voxels having a fractional value is based on the proportion of the refractive object occupying the voxel. In addition, the refractive index numbers are smoothed across the voxels of the second grid using a prescribed-sized Gaussian blur filter.

1.1.2 Octree Construction

The input to the octree construction stage of the rendering pipeline is a tolerance value ε and a 3D array containing the refractive index n for each voxel of a rectangular volume. The output is a representation of an octree within whose leaf nodes the refractive index is within ε of being constant. In one embodiment, because a GPU is being used rather than a CPU, the octree is represented in a form that is appropriate for construction and access by multiple parallel processing units. As such, the octree is output as a dense three-dimensional array of numbers, where the value in each voxel indicates the hierarchy level of the leaf node covering that voxel.

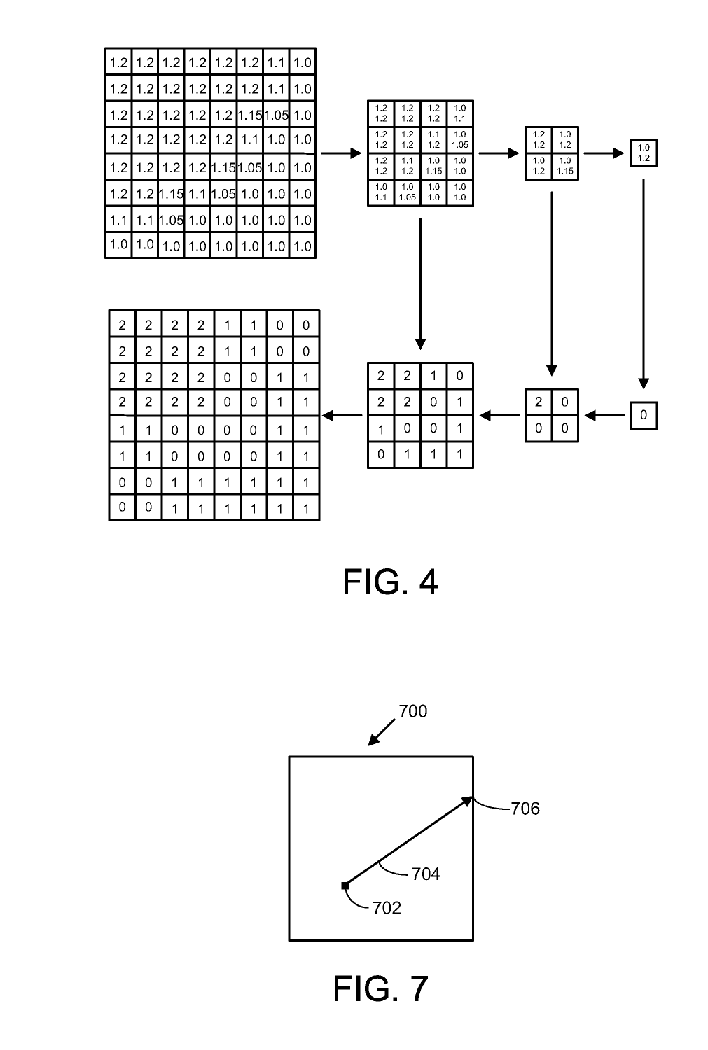

FIG. 4 illustrates the octree construction process, using a 2D example for the sake of simplicity and ε=0.05. A pyramid of 3D arrays that record the minimum and maximum refractive index present in each volumetric region is constructed first. This pyramid is then used along with the input tolerance ε to decide which level of the octree is sufficient to represent each of the original voxels.

More particularly, assume a cube-shaped volume of refractive index entries n of size 2^{K} in each dimension. A pyramid of K three-dimensional arrays is built, with each element storing the minimum and the maximum index of refraction (nₘᵢₙ and nₘₐₓ) for the corresponding portion of the volume. Next, another 3D array of size 2^{K} in each dimension is constructed, where each entry is an integer indicating the level of the octree sufficient to represent that portion of the volume. In one embodiment, zero is used as the label for the finest level of the octree and K is used as the label for the coarsest (single-voxel) level of the octree. The appropriate labels are determined by iterating from the coarsest level to the finest level of the pyramid, comparing each range of refractive index to the input tolerance. While examining pyramid level k, as soon as an entry satisfying nₘₐₓ-nₘᵢₙ≦ε is encountered, the corresponding volumetric region is assigned the label k. Once a voxel has been labeled with an octree level number, it is not labeled again.

It is noted that the appearance of caustics is quite sensitive to the photon marching step size. The step size, in turn, is dependent on the tolerance ε used in the octree construction. For some volumetric data, it has been found that it's very difficult to choose a tolerance that yields an accurate rendering with a reasonable number of photon marching steps. In particular, under some circumstances acceptable rendering quality demands such a low tolerance that the step sizes are too small to achieve interactive frame rates. An increase in the tolerance may cause many octree nodes to be merged, resulting in much larger step sizes and dramatically reduced rendering quality. In one optional embodiment, this situation can be avoided by modifying the octree construction to produce octree nodes with intermediate step sizes. More particularly, the octree storage is modified to associate each voxel with a maximum step size Δsₘₐₓ, in addition to the level number of the surrounding leaf-level octree node. This can be implemented by setting a voxel's step size limit Δsₘₐₓ to infinity, whenever a voxel is assigned an octree level number because the variation in refractive index is smaller than ε. If the variations in refractive index are larger than ε, but smaller than a second user specified tolerance ε′, then the voxel's Δsₘₐₓ is set to a finite step size limit chosen by the user. This scheme guarantees that within nodes of essentially constant refractive index, photons are advanced all the way to the node boundary, while within nodes with some variation in refractive index, the step size is limited. In tested embodiments, a primary tolerance value of ε=0.005 was employed, and an 8-voxel step size limit with a secondary tolerance of ε′=0.02 was used.

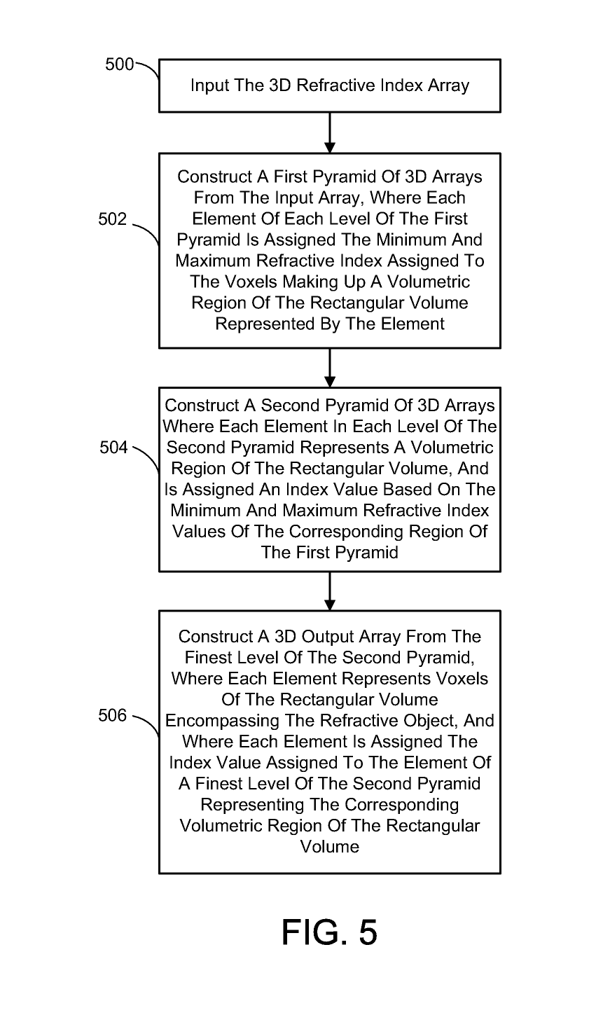

In one embodiment, octree construction is implemented as shown in FIG. 5. First, the previously-described 3D refractive index array generated in the object voxelization phase is input (500). As indicated previously, each element of the input array represents a voxel of a rectangular volume encompassing the voxels of the refractive object and each element is assigned the refractive index of the voxel corresponding to the element. A first pyramid of 3D arrays is constructed from the input array, where each element of each level of this first pyramid is assigned the minimum and maximum refractive index assigned to the voxels making up a volumetric region of the rectangular volume represented by the element (502). A second pyramid of 3D arrays is then constructed from the first pyramid, where each element in each level of the second pyramid represents a volumetric region of the rectangular volume, and is assigned an index value (504). In regard to the index value, starting from the coarsest level in each pyramid, a first index value is assigned to each element of the level of the second pyramid under consideration whenever the difference between the maximum and minimum refractive index values assigned to the element representing the corresponding volumetric region in the level of the first pyramid under consideration is greater than a prescribed tolerance value. However, an index value other than the first, which represents the level of the pyramid, is assigned to each element of the level of the second pyramid under consideration whenever the difference between the maximum and minimum refractive index values assigned to the element representing the corresponding volumetric region in the level of the first pyramid under consideration is less than or equal to the prescribed tolerance value. This is unless an index value other than the first is already assigned to an element of a level of the second pyramid. In that case, the same value is assigned to the elements in each finer level of the second pyramid corresponding to the element in the level assigned the value regardless of the difference between the maximum and minimum refractive index values assigned to the element in each finer level. A 3D output array is constructed next from the finest level of the second pyramid, where each element represents voxels of the rectangular volume encompassing the refractive object and where each element is assigned the index value assigned to the element of a finest level of the second pyramid representing the corresponding volumetric region of the rectangular volume (506). This output array represents the refractive index octree.

1.1.3 Photon Generation

In one embodiment, the initial positions and velocities of photons are set up so that the “camera” is positioned at a light source and oriented toward the volume of interest. Then, the faces that bound the volume are rendered. A texture is drawn in using a shader that records an alpha value of one along with the 3D position for each pixel representing a front-facing surface, while empty pixels are left with a value of zero. Next, this texture is transformed into a list of point primitives that represent photons, using either a geometry shader or a “scan” operation written in a general purpose GPU programming language like the Compute Unified Device Architecture language (CUDA). Each pixel with a non-zero alpha produces a single photon, where the photon's initial position is obtained from the 3D pixel location, the photon's direction is derived from the pixel coordinates and light position, and the photon's radiance is defined by the light's known emission characteristics.

When the scene consists of a solid transparent object, much of the volume surrounding the object consists of empty space, where the index of refraction is uniformly one. Thus, the amount of time spent tracing photons through this empty space can be reduced by generating the photons as close as possible to the interesting parts of the volume. To accomplish this, a proxy geometry can be rendered into a shadow map, rather than the bounding cube of the volume. Any bounding surface will do. For a complex object, a mesh that has been inflated to encompass the entire object can be employed.

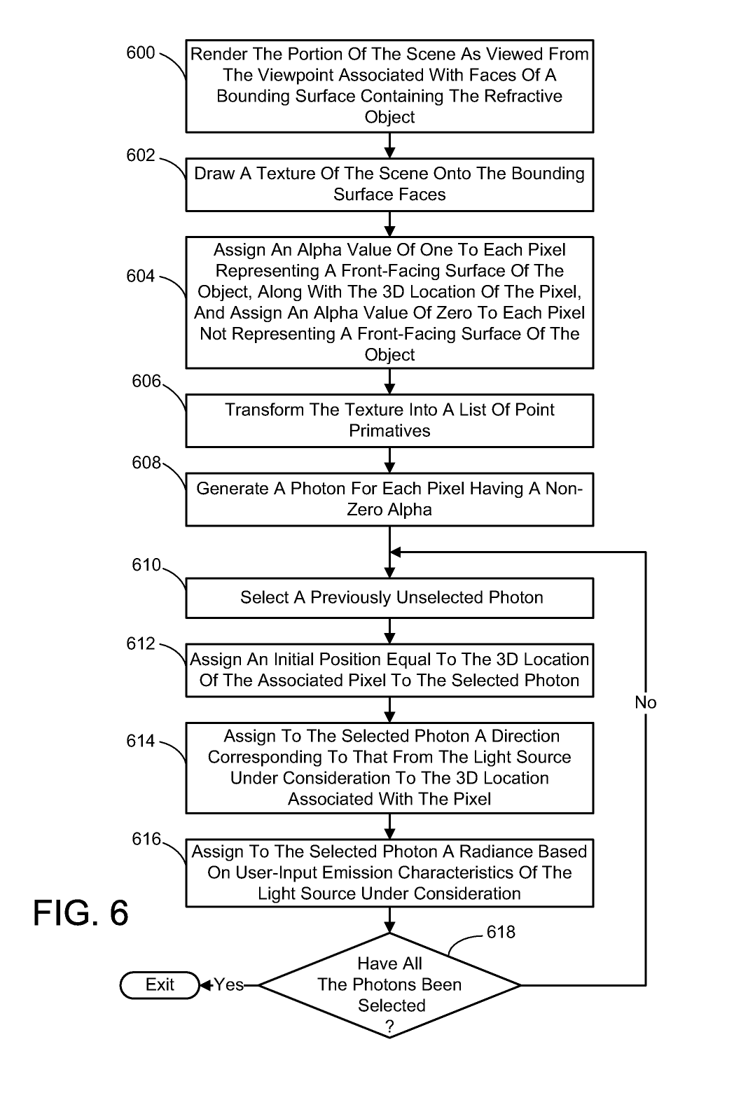

In one embodiment, photon generation is implemented as shown in FIG. 6. First, assuming a viewpoint at a light source location which is directed toward the refractive object, the portion of the scene as viewed from the viewpoint associated with faces of a bounding surface containing the object is rendered (600). A texture of the scene is then drawn onto the bounding surface faces of the rendered portion of the scene (602). Next, an alpha value of one is assigned to each pixel representing a front-facing surface of the object, along with the 3D location of the pixel, and an alpha value of zero is assigned to each pixel not representing a front-facing surface of the object (604). The texture is then transformed into a list of point primatives (606). A photon is generated for each pixel having a non-zero alpha (608), and a previously unselected photon is selected (610). An initial position equal to the 3D location of the associated pixel is assigned to the selected photon (612), as is a direction corresponding to the direction from the light source under consideration to the 3D location associated with the pixel (614). Finally, a radiance based on user-input emission characteristics of the light source under consideration is also assigned to the selected photon (616). It is then determined if all the photons have been selected (618). If not, actions 610 through 618 are repeated, until all the photons have been assigned the foregoing values.

1.1.4 Adaptive Photon Tracing

The general goal of the adaptive photon tracing stage is to advance each photon along its curved path, while simultaneously depositing radiance into the volumetric texture for later use. The input to this portion of the rendering pipeline consists of the octree representation of the refractive index values, a 3D array of RGB extinction coefficients, and a list of photons. Each of the photons is equipped with an initial position x₀, direction v₀, and a RGB radiance value \tilde{L}₀. The output is a 3D array of RGB radiance distributions describing the illumination that arrives at each voxel.

Each iteration of the adaptive photon tracing marches the photons one step forward according to Eqs. (4) and (5). For each photon, the octree is used to determine the largest step size Δs_{octree} that keeps the photon within a region of approximately constant refractive index, as shown in FIG. 7, where the step size is calculated to advance the photon 702 in its current direction 704 to the boundary 706 of the octree node 700. Next, Δs is chosen to be the larger of Δs_{octree} and a user-supplied minimum step size Δsₘᵢₙ. The minimum step size is typically the width of one or two voxels, and can be adjusted by the user to trade off accuracy for performance.

In each step, a photon loses a fraction of its radiance to absorption and out-scattering. The rate of exponential attenuation is determined by the local extinction coefficient, which is assumed to be approximately constant within the current octree node:

\tilde{L}ᵢ₊₁=\tilde{L}ᵢe^{-κ(x}^{ᵢ}^{)∥x}^{ᵢ₊₁}^{-x}^{ᵢ}^{∥}. (6)

Given the foregoing description of how to advance a photon by a single step, updating its position and direction according to Eqs. (4) and (5) and its radiance according to Eq. (6), it will now be described how the radiance distributions within the volume are accumulated according to one embodiment of the pipeline. In each voxel, the incoming radiance distribution is approximated by storing only a weighted average of the direction of arriving photons and a single radiance value for the red, green, and blue (RGB) wavelengths. This is clearly a very coarse approximation of the true distribution of radiance, but it is sufficient to reproduce the effects it is desired to render.

As a photon travels from xᵢ to xᵢ₊₁, it should contribute radiance to each of the voxels through which it passes. Therefore, every time a photon is advanced by a single step, two vertices are generated and placed into a vertex buffer to record the photon's old and new position, direction, and radiance values. Once all the photons have been marched forward one step, the vertex buffer is treated as a list of line segments to be rasterized into the output array of radiance distributions. The graphics pipeline is relied upon to interpolate the photon's position, direction, and radiance values between the two endpoints of each line segment. A pixel shader that adds the photon's radiance to the distribution stored in each voxel is used, and the photon's direction of travel is weighted by the sum of its RGB radiance values before adding it to the direction stored in each voxel.

After all the photons have been advanced and their contributions to the radiance distributions are stored, each photon that has permanently exited the volume or whose radiance has fallen below a low threshold value is eliminated, and then the entire process is repeated. The iterations are continued until the number of active photons is only a small fraction (e.g., 1/1000) of the original number of photons. As a final action, the volume of radiance distributions is smoothed using, for example, a 3×3×3 approximation of a Gaussian kernel to reduce noise.

There are several advantages to the foregoing adaptive photon tracing that are worth mentioning. First, an adaptive step size is used when marching each photon through the volume. As mentioned earlier, the octree structure is used to compute the longest step that remains within a region of nearly constant refractive index. Second, a voxel grid is used to store the radiance contributed by each photon to the illumination of the volume. The radiance distribution within every voxel that a photon passes through is updated, rather than recording radiance values only when a scattering event occurs.

It is noted that if the previously described octree construction is employed where octree nodes with intermediate step sizes are produced, a slight change is also made to the adaptive photon tracing stage. More particularly, the step size Δs is chosen by clamping Δs_{octree} between the user-specified minimum step size Δsₘᵢₙ and the octree node's maximum step size Δsₘₐₓ.

Given the foregoing, it is also noted that the GPU-based embodiments of the adaptive photon tracing stage divide the work into the photon marching pass, which calculates the new position, direction, and radiance of each photon after one step, and the photon storage pass, which accumulates radiance into the volume. For the photon storage part, the rendering pipeline is relied upon to rasterize line segments into the volume texture representing the radiance distributions. However, many GPUs can only rasterize a line segment into a single 2D slice of a 3D volume texture. If such a GPU is employed, smaller steps must be taken than octree might otherwise allow. In such a case, two optional strategies can be employed to mitigate this issue.

First, instead of storing all the photon radiance in a 3D texture with a single slice orientation, a texture is used that has triple the number of slices and includes slices in all three orientations (i.e., three blocks of slices normal to the x, y, and z axes). Whenever a photon takes a step, a portion of the texture is chosen to rasterize the resulting line segment into based on the direction of the photon's motion. The slice orientation in which the photon can travel farthest before exiting a slice is always chosen.

Second, the effective thickness of each slice is doubled by separating the volume texture into two render targets, one containing the even-numbered slices and the other containing odd-numbered slices (of all three orientations). When rasterizing a line segment, it is rendered into an even and an odd slice simultaneously, using a fragment shader to draw or mask the pixels that belong in each. In all, four render targets are used because radiance values and directions are stored in separate textures and the odd and even slices are split into separate textures. The added costs of having multiple slice orientations and multiple render targets are significantly outweighed by the speed-ups offered by longer photon step sizes.

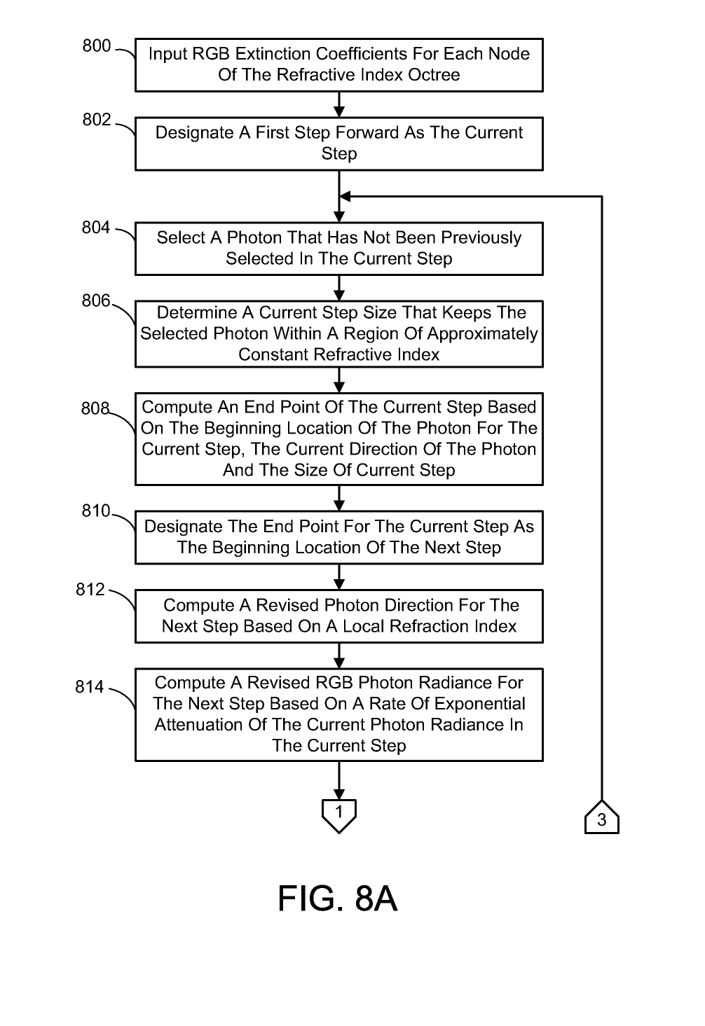

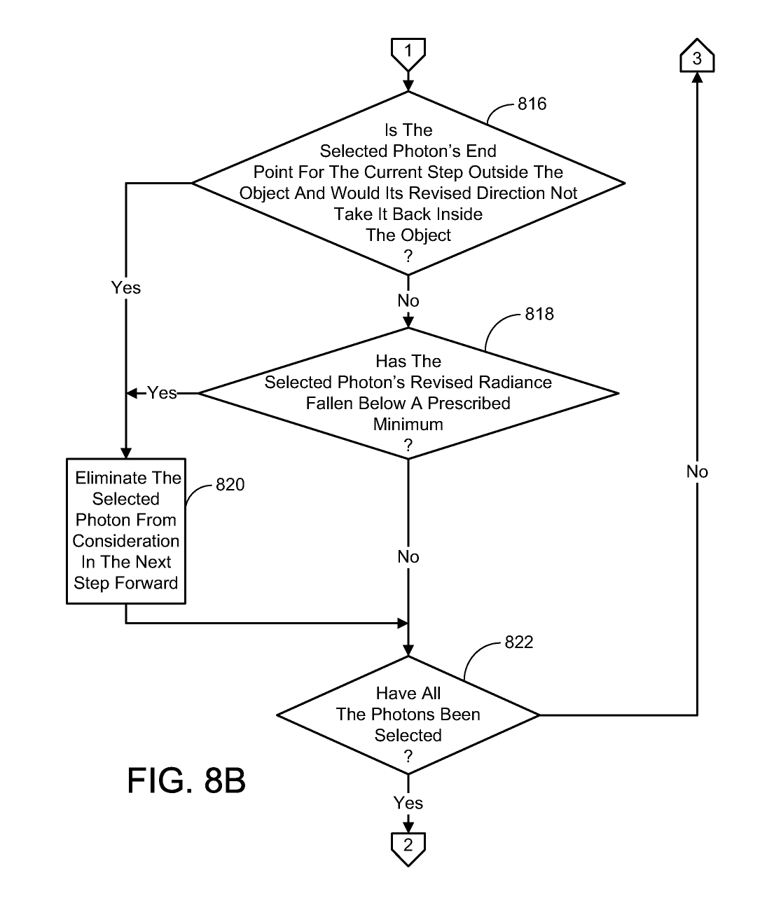

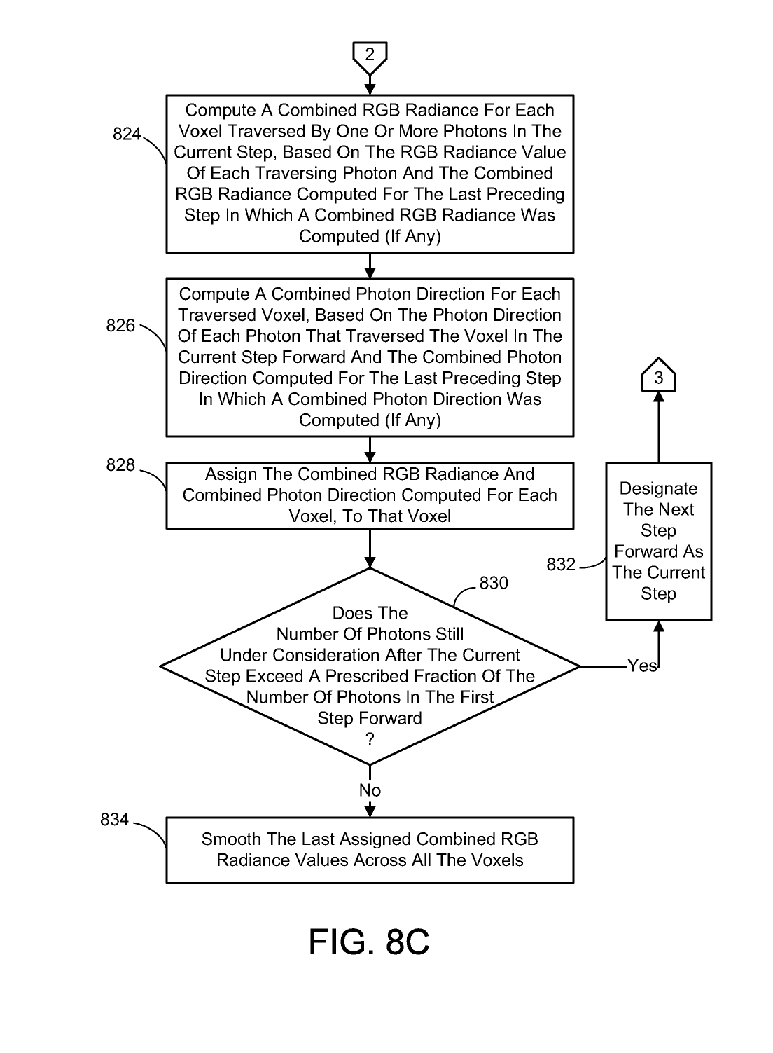

In one embodiment, adaptive photon tracing is implemented as shown in FIGS. 8A-C. First, user-provided RGB extinction coefficients are input for each node of the refractive index octree (800). Then, a first step forward is designated as the current step (802), and a photon that has not been previously selected in the current step is selected (804). A size of the current step that keeps the selected photon within a region of approximately constant refractive index is determined using the refractive index octree (806). Next, an end point of the current step is computed based on the beginning location of the photon for the current step (which is its initial location in the case of the first step), the current direction of the photon (which is taken from the refractive index octree) and the determined size of current step (808). The computed end point for the current step is designated as the beginning location of the next step (810). A revised photon direction for the next step is then computed based on the local refraction index (812), and a revised RGB photon radiance is computed for the next step based on a rate of exponential attenuation of the current photon radiance caused by absorption and scattering in the current step (814). This attenuation is determined based on the RGB extinction coefficient of the octree node associated with the current step. It is then determined for the selected photon if its computed end point for the current step is outside the refractive object and its revised direction would not take it back inside the object (816). If the selected photon is not determined to be permanently outside the refractive object, then it is determined if its revised radiance has fallen below a prescribed minimum radiance threshold (818). If it is determined that the selected photon is either permanently outside the refractive object after the current step, or that its revised radiance has fallen below the prescribed minimum radiance threshold, then the photon is eliminated from consideration in the next step forward (820). However, if the selected photon is not permanently outside the refractive object after the current step, and its revised radiance has not fallen below the prescribed minimum radiance threshold, it is next determined if all the photons have been selected (822). If not, actions 804 through 822 are repeated.

After all the photons have been selected and processed as described above, a combined RGB radiance is computed for each voxel traversed by one or more photons in the current step, based on the RGB radiance value of each traversing photon and the combined RGB radiance computed for the last preceding step in which a combined RGB radiance was computed, if any (824). A combined photon direction is also computed for each traversed voxel, based on the photon direction of each photon that traversed the voxel in the current step forward and the combined photon direction computed for the last preceding step, in which a combined photon direction was computed if any (826). In one embodiment, the photon direction of each photon that traversed a voxel in the current step forward is weighted in accordance with a scalar representation of the photon's RGB radiance prior to being combined. Next, the combined RGB radiance and combined photon direction computed for each voxel are assigned to that voxel (828).

It is next determined if the number of photons still under consideration after the current step exceeds a prescribed fraction of the number of photons under consideration in the first step forward (830). If so, then the procedure continues with the next step forward being designated as the current step (832), and repeating actions 804 through 832. However, if the number of photons still under consideration does not exceed the prescribed fraction, then the last assigned combined RGB radiance values are smoothed across all the voxels (834), and the procedure ends.

1.1.5 Rendering

Once the photon tracing pass is complete, images can be rendered from arbitrary viewpoints. The rendering stage generally involves tracing backwards along the paths that light rays take to reach a “camera”, summing up the radiance contributed by each of the voxels that are traversed (after accounting for the scattering phase function and attenuation due to absorption and out-scattering).

In one embodiment the rendering is accomplished by first initializing the origin and direction of a single ray for each pixel of the output image. If the ray intersects the rectangular volume of interest, the ray is marched along step-by-step until it exits the volume. Eqs. (4) and (5) are used to determine the paths taken by viewing rays, in the same way the photon tracing was handled. However, in one embodiment, when tracing viewing rays, a fixed step size is used that is equivalent to the width of one voxel, rather than using an adaptive step size. There are several reasons to use a fixed step size. First, this avoids missing the contribution of any of the voxels along the light ray's path. In addition, image artifacts caused by different step sizes are not introduced among adjacent pixels. Further, from a practical standpoint, the rendering is so much faster than the adaptive photon tracing stage that it needs no acceleration.

At each step along a viewing ray, the radiance value and direction stored in the corresponding voxel is accessed, and then the scattering phase function is evaluated to determine how much of the radiance is scattered from the incident direction toward the “camera”. The result is multiplied by the local scattering coefficient σ(x) and the total attenuation along the ray due to absorption and out-scattering. The total attenuation along the ray is defined in terms of the attenuation after each step back. For example, after “b” steps back, the radiance reaching the user-specified viewpoint would be I₁A₁+I₂A₁A₂+I₃A₁A₂A₃+ . . . +I_{b}A₁A₂A₃ . . . A_{b}., where I is radiance scattered from the incident direction toward the desired viewpoint multiplied by the local scattering coefficient σ(x) and A is the attenuation associated with a step back. The foregoing product gives the radiance contribution of a single voxel, which is then added to the total radiance of the current viewing ray. Once the ray exits the volume, any background radiance is incorporated to complete the calculation of an output pixel color.

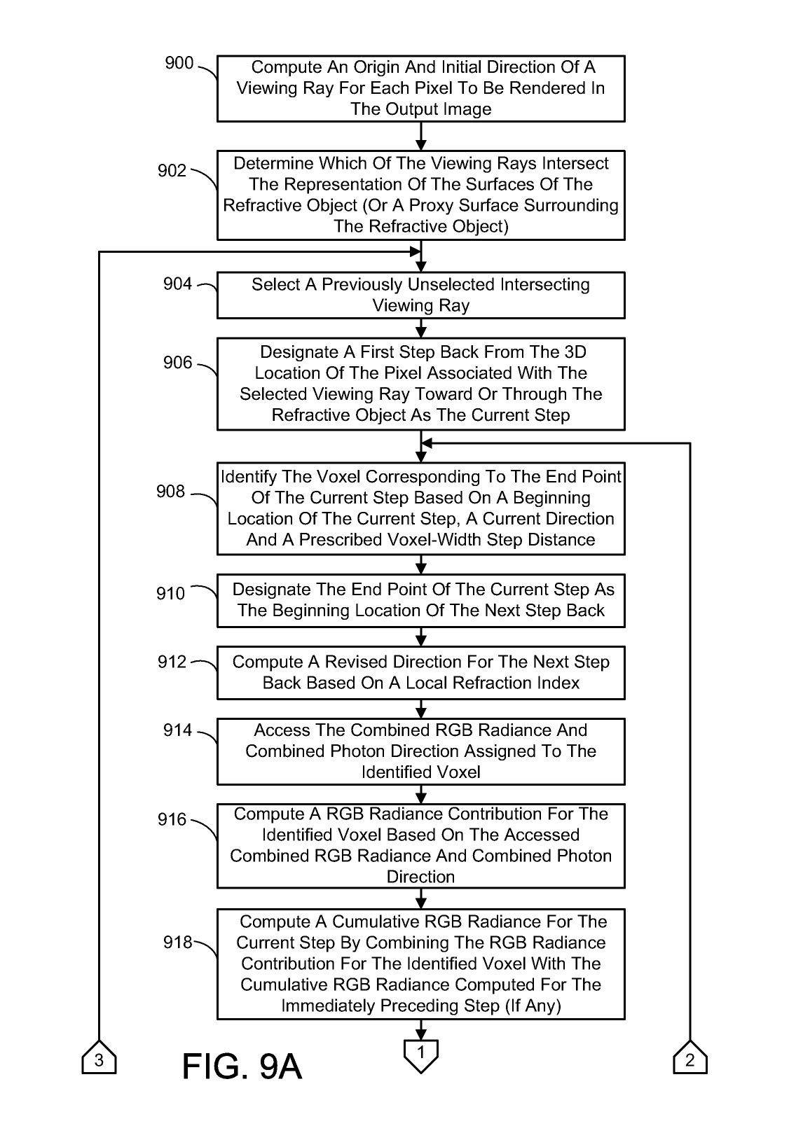

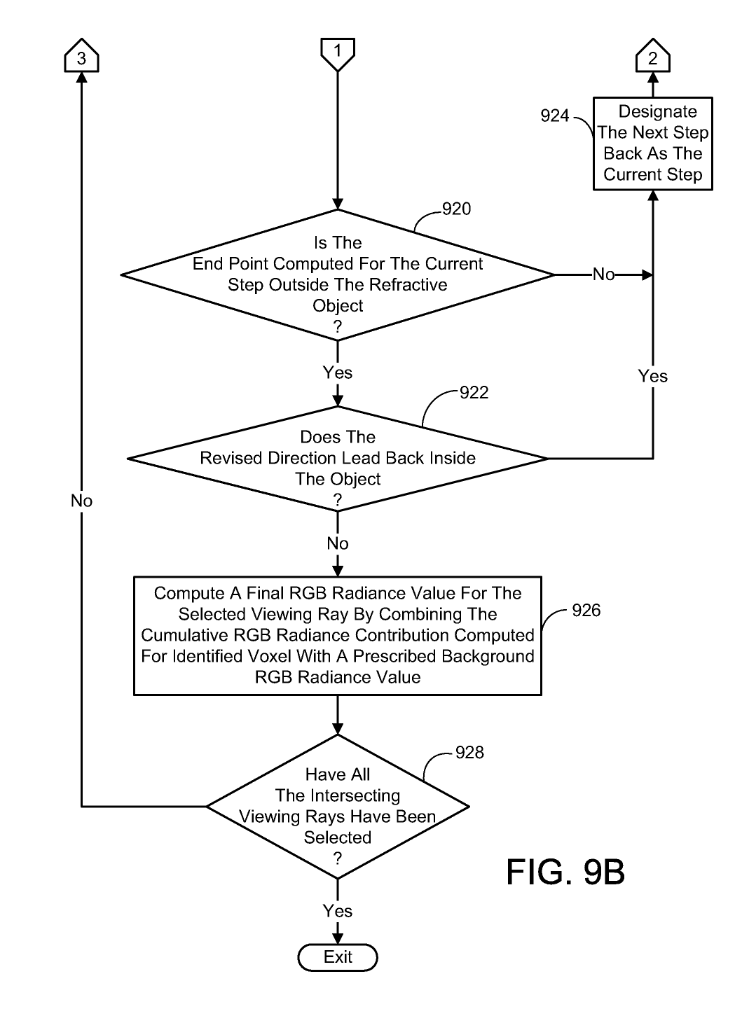

In one embodiment, the foregoing rendering is implemented as shown in FIGS. 9A-B. First, an origin and initial direction of a viewing ray for each pixel to be rendered in the output image is computed (900). The origin of each viewing ray corresponds to the 3D location of the associated pixel and the initial direction of the ray is along a line from the user-specified viewpoint to the 3D location of the pixel. It is next determined which of the viewing rays intersect the representation of the surfaces of the refractive object (or a proxy surface surrounding the refractive object) based on their initial directions (902). A previously unselected intersecting viewing ray is then selected (904), and a first step back from the 3D location of the pixel associated with the selected viewing ray toward or through the refractive object is designated as the current step (906). The voxel corresponding to the end point of the current step is identified based on a beginning location of the current step (which is the 3D location of the pixel associated with the selected viewing ray for the first step back), a current direction (which is the initial direction of the selected ray for the first step back) and a prescribed voxel-width step distance (908). In addition, the end point of the current step is designated as the beginning location of the next step back (910), and a revised direction for the next step back is computed based on the local refraction index (912).

The combined RGB radiance and combined photon direction assigned to the identified voxel is accessed next (914). A RGB radiance contribution for the identified voxel is computed based on the accessed combined RGB radiance and combined photon direction (916) as described above. A cumulative RGB radiance for the current step is then computed by combining the RGB radiance contribution computed for the identified voxel with the cumulative RGB radiance computed for the immediately preceding step, if any (918).

It is next determined if the end point computed for the current step is outside the refractive object (920). If outside, it is determined if the revised direction leads back inside the object (922). If it is determined that the end point computed for the current step is inside the refractive object, or that it is outside, but the revised direction leads back inside the object, then the procedure continues by designating the next step back from the 3D location of the pixel associated with the selected viewing ray toward and through the refractive object as the current step (924), and repeating actions 908 through 924, as appropriate. If it is determined that the end point computed for the current step is outside the refractive object and the revised direction does not leads back inside the object, then a final RGB radiance value is computed for the selected viewing ray by combining the cumulative RGB radiance contribution computed for identified voxel with a prescribed background RGB radiance value (926). It is then determined if all the intersecting viewing rays have been selected (928). If not, then actions 904 through 928 are repeated, as appropriate. Otherwise the rendering procedure ends.

2.0 General Purpose GPU Programming Language vs. Graphics API

In tested embodiments, the general purpose GPU programming language CUDA was employed to construct the octree, generate photons from a shadow map, and advance photons through the volume. Whereas, the Open Graphics Library (OpenGL), an API for writing applications that produce 2D and 3D computer graphics, was used to voxelize objects, create the shadow map, rasterize photon contributions into the volume, and to integrate radiance along viewing rays. The interleaving of these actions requires that the shadow map, the refractive index volume, and the extinction coefficient volume be copied from OpenGL to CUDA. It is noted that the list of line segments generated by the CUDA implementation of photon marching can be shared with the OpenGL implementation of photon storage to increase efficiency, because the list is a one-dimensional buffer.

There are several trade-offs to consider when choosing between using CUDA (or a similar framework) for general-purpose computation on the GPU and using OpenGL (or a similar API) to access the GPU's graphics pipeline. CUDA offers an advantage to the developer when writing algorithms that don't divide nicely into a vertex shader, a geometry shader, and a fragment shader. It makes more sense to write general-purpose code than to massage the code into these artificially separated pieces. The costs associated with texture filtering and rasterization operations can also be saved when they are not needed. These advantages come at a cost, however, when mixing general purpose computation with graphics-specific operations. For example, in tested embodiments, time is spent copying data back and forth between CUDA and OpenGL. In addition, a graphics card that supports CUDA has to be employed. Further, these technologies currently can share data in one dimensional buffers, but not 2D or 3D textures. Added efficiency can be achieved if CUDA and OpenGL are modified to share two and three-dimensional textures.

3.0 The Computing Environment

A brief, general description of a suitable computing environment in which portions of the dynamic refractive object relighting technique embodiments described herein may be implemented will now be described. The technique embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 10 illustrates an example of a suitable computing system environment. The computing system environment is only one example of a suitable computing environment and is not intended to suggest any limitation as to the scope of use or functionality of dynamic refractive object relighting technique embodiments described herein. Neither should the computing environment be interpreted as having any dependency or requirement relating to any one or combination of components illustrated in the exemplary operating environment. With reference to FIG. 10, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 10 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 10 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well know in the art and need not be discussed at length here.

The dynamic refractive object relighting technique embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

4.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A system for rendering an image of a refractive object in a dynamic scene at an interactive rate so as to depict the effects of refraction, absorption, and anisotropic scattering of light on the object, comprising:
a general purpose computing device, and
a computer program having program modules executable by the computing device, comprising,
an object voxelization module for,
converting a representation of the surfaces of the refractive object into a volumetric representation of object in the form of a rectangular voxel grid whenever said refractive object surfaces representation is input in lieu of a volumetric object representation, and
assigning user-input material parameters comprising a refractive index to each voxel of the volumetric object representation,
a photon tracing module for tracing paths of photons in a step-wise manner as each photon refracts through the object and assigning radiance values to all the voxels that the photon traverses, wherein the size of each step forward through the refractive object is variable and based on variations in refractive index derived from an octree representation of the object's refractive indexes, and
a rendering module for rendering an output image of the refractive object from a user-input viewpoint by tracing viewing rays from the viewpoint into the scene and calculating the amount of radiance that reaches the viewpoint along each of the rays.

2. The system of claim 1, wherein the photon tracing module comprises an octree construction sub-module for analyzing the refractive index of each voxel and producing a refractive index octree that indicates the regions of object in which the refractive index is deemed to be constant.

3. The system of claim 2, wherein the octree construction sub-module comprises sub-modules for:
inputting a three-dimensional array wherein each element of the input array represents a voxel of a rectangular volume encompassing the voxels of the refractive object and wherein each element is assigned the refractive index of the voxel corresponding to the element;
constructing a first pyramid of three-dimensional arrays from the input array, wherein each element of each level of the first pyramid is assigned the minimum and maximum refractive index assigned to the voxels making up a volumetric region of the rectangular volume represented by the element;
constructing a second pyramid of three-dimensional arrays from the first pyramid, wherein each element in each level of the second pyramid represents a volumetric region of the rectangular volume, and wherein starting from the coarsest level in each pyramid,
a first index value is assigned to each element of the level of the second pyramid under consideration whenever the difference between the maximum and minimum refractive index values assigned to the element representing the corresponding volumetric region in the level of the first pyramid under consideration is greater than a prescribed tolerance value, and
an index value other than the first which represents the level of the pyramid is assigned to each element of the level of the second pyramid under consideration whenever the difference between the maximum and minimum refractive index values assigned to the element representing the corresponding volumetric region in the level of the first pyramid under consideration is less than or equal to the prescribed tolerance value, except whenever an index value other than the first is assigned to an element of a level of the second pyramid, that same value is assigned to the elements in each finer level of the second pyramid corresponding to the element in the level assigned the value regardless of the difference between the maximum and minimum refractive index values assigned to the element in each finer level; and
constructing a three-dimensional output array representing the refractive index octree from the finest level of the second pyramid, wherein each element of the output array represents voxels of the rectangular volume encompassing the refractive object and wherein each element of the output array is assigned the index value assigned to the element of a finest level of the second pyramid representing the corresponding volumetric region of the rectangular volume.

4. The system of claim 2, wherein the photon tracing module comprises a photon generation sub-module for generating a list of photons associated with each light source illuminating the scene, said photons being defined by an initial position, a direction and a radiance value, and are based on user-input lighting parameters associated with one or more light source locations.

5. The system of claim 4, wherein for each light source, the photon generation sub-module comprises sub-modules for:
assuming a viewpoint at the light source location which is directed toward the refractive object, rendering the portion of the scene as viewed from the viewpoint associated with faces of a bounding surface containing the object;
drawing a texture of the scene onto the bounding surface faces of the rendered portion of the scene;
assigning an alpha value of one to each resulting pixel representing a front-facing surface of the object, along with the three-dimensional location of the pixel;
assigning an alpha value of zero to each resulting pixel not representing a front-facing surface of the object;
transforming the texture into a list of point primatives;
generating a photon for each pixel having a non-zero alpha, and for each photon,
assigning an initial position equal to the three-dimensional location of the associated pixel,
assigning a direction corresponding to the direction from the light source under consideration to the three-dimensional location associated with the pixel,
assigning a radiance based on user-input emission characteristics of the light source under consideration.

6. The system of claim 5, wherein the bounding surface is one of a bounding cube or a mesh that has been inflated to encompass the entire object.

7. The system of claim 4, wherein the photon tracing module comprises an adaptive photon tracing sub-module for advancing each photon along its path through the refractive object, while at each step along each photon path a radiance value attributable to that photon is associated with each voxel traversed, wherein a combined radiance is assigned to each voxel traversed by one or more photons after each step forward which represents a combination of the radiance attributed to each photon traversing the voxel in the current and previous steps, and wherein a combined photon direction is assigned to each voxel traversed by one or more photons after each step forward which represents a combination of the directions of each photon traversing the voxel in the current and previous steps.

8. The system of claim 7, wherein the combined photon direction assigned to each voxel after each step forward represents a weighted combination of the directions of each photon traversing the voxel in the current and previous steps, wherein each photon direction is weighted in accordance with its radiance prior to being combined.

9. The system of claim 7, wherein adaptive photon tracing sub-module comprises sub-modules for:
inputting RGB extinction coefficients for each node of the refractive index octree;
for each photon and each current step forward from the starting point of the photon under consideration,
determining the size for a current step that keeps the photon within a region of approximately constant refractive index using the refractive index octree,
computing the end point of the current step based on the beginning location of the photon for the current step, the current direction of the photon and the determined size of current step, wherein the starting point of the photon is the beginning location for the first step,
designating the end point of the current step as the beginning location of the next step,
computing a revised photon direction for the next step based on a local refraction index,
computing a revised RGB photon radiance for the next step based on a rate of exponential attenuation of the current photon radiance caused by absorption and scattering in the current step, wherein the attenuation is determined based on the RGB extinction coefficient of the octree node associated with the current step;
for each current step forward, after a revised RGB radiance value and photon direction has been computed for each photon considered,
computing a combined RGB radiance for each traversed voxel based on the RGB radiance value of each photon that traversed the voxel in the current step forward and the combined RGB radiance computed for the last preceding step in which a combined RGB radiance was computed, if any,
computing a combined photon direction for each traversed voxel based on the photon direction of each photon that traversed the voxel in the current step forward and the combined photon direction computed for the last preceding step in which a combined photon direction was computed, if any, wherein the photon direction of each photon that traversed the voxel in the current step forward is weighted in accordance with a scalar representation of the photon's RGB radiance prior to being combined,
assigning to each traversed voxel the combined RGB radiance and combined photon direction computed for that voxel;
for each current step forward,
determining for each photon whether its end point after the current step is outside the refractive object and its revised direction would not take it back inside the object such that it is permanently outside the refractive object,
determining for each photon if its revised radiance has fallen below a prescribed minimum radiance threshold, and
eliminating from consideration in the next step forward each photon that has either been determined to be permanently outside the refractive object or whose radiance has fallen below the prescribed minimum radiance threshold;
whenever the number of photons still under consideration for the next step forward exceeds a prescribed fraction of the number of photons under consideration in the first step forward, proceeding with the next step forward as the current step forward; and
whenever the number of photons still under consideration for the next step forward does not exceed the prescribed fraction of the number of photons under consideration in the first step forward, not proceeding with the next step forward, and smoothing the last assigned combined RGB radiance values across all the voxels associated with the refractive object.

10. The system of claim 9, wherein the sub-module for determining the size for a current step, comprises sub-modules for:
employing the octree to identify the octree distance from the beginning location of the photon for the current step, in the current direction of the photon, to the boundary of the octree node containing the beginning location of the photon for the current step;
determining if the octree distance or a prescribed minimum step size is larger; and
setting the size of the current step to be the larger of the octree distance and the prescribed minimum step size.

11. The system of claim 9, wherein the octree construction sub-module comprises sub-modules for:
inputting a three-dimensional array wherein each element of the input array represents a voxel of a rectangular volume encompassing the voxels of the refractive object and wherein each element is assigned the refractive index of the voxel corresponding to the element;
constructing a first pyramid of three-dimensional arrays from the input array, wherein each element of each level of the first pyramid is assigned the minimum and maximum refractive index assigned to the voxels making up a volumetric region of the rectangular volume represented by the element;
constructing a second pyramid of three-dimensional arrays from the first pyramid, wherein each element in each level of the second pyramid represents a volumetric region of the rectangular volume, and wherein starting from the coarsest level in each pyramid,
a first index value is assigned to each element of the level of the second pyramid under consideration whenever the difference between the maximum and minimum refractive index values assigned to the element representing the corresponding volumetric region in the level of the first pyramid under consideration is greater than a first prescribed tolerance value,
additionally assigning a prescribed finite maximum step size to each element of the level of the second pyramid under consideration whenever the difference between the maximum and minimum refractive index values assigned to the element representing the corresponding volumetric region in the level of the first pyramid under consideration is greater than the first prescribed tolerance value, but smaller than a second prescribed tolerance value, wherein the second prescribed tolerance value is larger than the first prescribed tolerance value,
an index value other than the first which represents the level of the pyramid is assigned to each element of the level of the second pyramid under consideration whenever the difference between the maximum and minimum refractive index values assigned to the element representing the corresponding volumetric region in the level of the first pyramid under consideration is less than or equal to the prescribed tolerance value, except whenever an index value other than the first is assigned to an element of a level of the second pyramid, that same value is assigned to the elements in each finer level of the second pyramid corresponding to the element in the level assigned the value regardless of the difference between the maximum and minimum refractive index values assigned to the element in each finer level; and
additionally assigning an infinite maximum step size to each element of the level of the second pyramid under consideration whenever the difference between the maximum and minimum refractive index values assigned to the element representing the corresponding volumetric region in the level of the first pyramid under consideration is less than or equal to the prescribed tolerance value,
constructing a three-dimensional output array representing the refractive index octree from the finest level of the second pyramid, wherein each element of the output array represents a voxel of the rectangular volume encompassing the voxels of the refractive object and wherein each element of the output array is assigned the index value assigned to the element of a finest level of the second pyramid representing the corresponding volumetric region of the rectangular volume.

12. The system of claim 11, wherein the sub-module for determining the size for a current step, comprises sub-modules for:
employing the octree to identify the octree distance from the beginning location of the photon for the current step, in the current direction of the photon, to the boundary of the octree node containing the beginning location of the photon for the current step;
determining if the octree distance or a prescribed minimum step size is larger;
whenever the octree distance is larger than the prescribed minimum step size, determining if the octree distance or the prescribed maximum step size assigned to the octree node containing the beginning location of the photon for the current step is larger; and
setting the size of the current step to be the smaller of the octree distance and the prescribed maximum step size.

13. The system of claim 7, wherein rendering module comprises sub-modules for:
computing an origin and initial direction of a viewing ray for each pixel to be rendered in the output image, said origin corresponding with the three-dimensional location of the pixel under consideration and the initial direction being along a line from the user-specified viewpoint to the three-dimensional location of the pixel;
determining for each viewing ray if it intersects the representation of the surfaces of the refractive object or a proxy surface surrounding the refractive object based on its initial direction; and
for each viewing ray that intersects the representation of the surfaces of the refractive object or a proxy surface surrounding the refractive object,
for each current step back from the three-dimensional location of the pixel associated with the viewing ray under consideration toward or through the refractive object,
identifying the voxel corresponding to the end point of the current step based on a beginning location of the current step, a current direction and a prescribed voxel-width step distance, wherein the three-dimensional location of the pixel associated with the viewing ray under consideration is the beginning location for the first step,
designating the end point of the current step as the beginning location of the next step,
computing a revised direction for the next step based on a local refraction index,
accessing the combined RGB radiance and combined photon direction assigned to the identified voxel,
computing a RGB radiance contribution for the identified voxel based on the combined RGB radiance and combined photon direction assigned thereto, and
computing a cumulative RGB radiance for the current step by combining the RGB radiance contribution computed for the identified voxel with the cumulative RGB radiance computed for the immediately preceding step, if any,
for each current step back, after the cumulative RGB radiance for the current step has been computed,
determining whether the end point computed for the current step is outside the refractive object and the revised direction does not lead back inside the object,
whenever the end point computed for the current step is not outside the refractive object, or the end point computed for the current step is outside the refractive object but the revised direction leads back inside the object, proceeding with the next step back as the current step back, and
whenever the end point computed for the current step is outside the refractive object and the revised direction does not lead back inside the object, computing a final RGB radiance value for the viewing ray under consideration by combining the cumulative RGB radiance contribution computed for identified voxel with a prescribed background RGB radiance value.

14. The system of claim 13, wherein the sub-module for computing the RGB radiance contribution for the identified voxel based on the combined RGB radiance and combined photon direction assigned thereto, comprises the sub-modules for:
employing a scattering phase function to determine how much of the combined RGB radiance is scattered from the incident direction toward the user-input viewpoint; and
multiplying the scattering phase function result by the RGB scattering coefficient associated with the identified voxel and the total attenuation associated with all previous steps due to absorption and scattering, to produce the RGB radiance contribution for the identified voxel.

15. The system of claim 1, wherein the general purpose computing device comprises a graphics processing unit (GPU) and wherein the computer program modules are executed using the GPU.

16. A computer-implemented process for rendering an image of a refractive object in a dynamic scene at an interactive rate so as to depict the effects of refraction, absorption, and anisotropic scattering of light on the object, comprising using a computer to perform the following process actions:
voxelizing a representation of the surface of the refractive object into a volumetric representation of object in the form of a rectangular voxel grid;
assigning a refractive index to each voxel of the volumetric object representation based on user-input material parameters;
tracing paths of photons in a step-wise manner as each photon refracts through the object and assigning radiance values to all the voxels that the photons traverse; and
rendering an output image of the refractive object from a user-input viewpoint by tracing viewing rays from the viewpoint into the scene and calculating the amount of radiance that reaches the viewpoint along each of the rays.

17. The process of claim 16, wherein the process action of voxelizing a representation of the surfaces of the refractive object into a volumetric representation of object in the form of a rectangular voxel grid, comprises the actions of:
voxelizing the representation of the refractive object surfaces into a first rectangular voxel grid that has a prescribed resolution which is greater than that of a desired resolution;
assigning a zero to voxels of the first grid whose centers lie outside the surface and a one to voxels whose centers lie on or inside the surface;
voxelizing the representation of the refractive object surfaces into a second rectangular voxel grid that has said desired resolution;
assigning a zero to voxels of the second grid whose centers lie outside the surface and a one to voxels whose centers lie on or inside the surface;
for each voxel of the second grid, determining whether all the assigned values in a prescribed-sized surrounding neighborhood are the same,
whenever all the assigned values in the surrounding neighborhood are the same, no change is made to the assigned value of the voxel under consideration, and
whenever any of the assigned values in the surrounding neighborhood are not the same, downsampling the region of the first grid corresponding to said surrounding neighborhood of the second grid to obtain a fractional value which is then assigned to the voxel under consideration in lieu of the previously assigned value.

18. The process of claim 17, wherein the process action of assigning a refractive index to each voxel of the volumetric object representation based on user-input material parameters, comprises the actions of:
assigning a refractive index to each voxel of the second grid based on the user input material parameters, wherein the refractive index assigned to voxels having a fractional value is based on the proportion of the refractive object occupying the voxel; and
smoothing the refractive index numbers across the voxels of the second grid using a prescribed-sized Gaussian blur filter.

19. The process of claim 18, wherein the prescribed-sized surrounding neighborhood is a 3×3×3 voxel block centered on the voxel under consideration, the prescribed resolution of the first grid is four times that of the resolution of the second grid, and the prescribed-sized Gaussian blur filter is a 9×9×9 voxel Gaussian blur kernel.

20. A computer-readable medium having computer-executable instructions for rendering an image of a refractive object in a dynamic scene at an interactive rate so as to depict the effects of refraction, absorption, and anisotropic scattering of light on the object, said computer-executable instructions comprising:
voxelizing a representation of the surface of the refractive object into a volumetric representation of object in the form of a rectangular voxel grid;
assigning a refractive index to each voxel of the volumetric object representation based on user-input material parameters;
tracing paths of photons in a step-wise manner as each photon refracts through the object and assigning radiance values to all the voxels that the photon traverses, wherein the size of each step forward through the refractive object is variable and based on variations in refractive index derived from an octree representation of the object's refractive indexes; and
rendering an output image of the refractive object from a user-input viewpoint by tracing viewing rays from the viewpoint into the scene and calculating the amount of radiance that reaches the viewpoint along each of the rays.
